(19) United States
(12) Patent Application Publication
(10) Pub. No.: US 2011/0201499 A1
(43) Pub. Date: Aug. 18, 2011

(54) Method of Improving Plant Yield of Soybeans by Treatment with Herbicides

(76) Inventors: Jayla Allen, Apex, NC (US); Fred Arnold, Champaign, IL (US); John Hinz, Story City, IA (US)

(21) Appl. No.: 13/023,909

(22) Filed: Feb. 9, 2011

Related U.S. Application Data
(60) Provisional application No. 61/303,932, filed on Feb. 12, 2010.

(51) Int. Cl. A01N 25/32; A01N 57/20; A01N 59/00; A01P 7/00; A01P 3/00; A01P 13/00

(52) U.S. Cl. 504/103; 504/128; 504/124

(57) ABSTRACT

A method of improving the yield of a soybean plant is provided, comprising the steps of applying an effective amount of a first herbicidal treatment composition to the soil surface prior to soybean plant emergence, followed by applying an effective amount of a second herbicidal treatment composition to soybeans post-emergence. The first herbicidal treatment composition comprises isoxaflutole, while the second herbicidal treatment composition comprises glyphosate and/or glufosinate.

### FIELD OF THE INVENTION

The present invention is directed to methods of improving plant yield in soybeans by staged treatment with herbicides.

### BACKGROUND OF THE INVENTION

Soybeans are a valuable global crop, providing oil and protein to various markets. Most harvested soybeans are solvent-extracted for vegetable oil and then defatted. Soymeal is used for animal feed. A small proportion of the crop is consumed directly by humans. Soybean products also appear in a large variety of processed foods.

Soybeans are native to East Asia, but only 45 percent of soybean production occurs there. The majority of production is in the Americas. The U.S. produced 87.7 million metric tons of soybeans in 2006, of which more than one-third was exported. Other leading producers are Brazil, Argentina, China, and India.

In the last fifteen years, soybeans have been genetically modified (GM), and GM soybeans are being used in an increasing number of products. Genetic modification of soybeans is done in large part in an effort to improve the plant's resistance to herbicides. In 1995 Monsanto introduced Roundup Ready (RR) soybeans that have been genetically modified to be resistant to the herbicide Roundup (glyphosate) through substitution of the Agrobacterium sp. (strain CP4) gene EPSP (5-enolpyruvyl shikimic acid-3-phosphate) synthase. The substituted version is not sensitive to glyphosate. This greatly improves the ability to control weeds in soybean fields since glyphosate can be sprayed on fields without hurting the crop. As of 2006, 89% of U.S. soybean fields were planted with glyphosate resistant varieties, compared to about 8% in 1997.

There remain concerns that other herbicides could detrimentally affect soybean plant vigor, resulting in reduced yields.

### SUMMARY OF THE INVENTION

In accordance with the present invention, it has been surprisingly found that not only can yield loss of soybeans due to herbicides be prevented, but the yield of soybeans can actually be significantly increased by application of an effective amount of a first herbicide composition to soil in the pre-emergence stage, followed by application of an effective amount of a second herbicide composition in the post-emergence stage. Correspondingly, a method of improving the yield of a soybean plant is provided by the present invention. By “improving the yield of a plant” is meant that a soybean plant produces more seed when soybeans have been treated in accordance with the method of the present invention, compared to soybeans that have not been so treated. By “pre-emergence” or “prior to emergence” is meant that the soil surface is treated prior to, during, or after planting, of soybeans, including after germination, but before plant emergence from the soil surface. The method comprises the steps of (i) applying an effective amount of a first herbicidal treatment composition to soybeans the soil surface prior to plant emergence, wherein the first herbicidal treatment composition comprises isoxaflutole; and (ii) applying an effective amount of a second herbicidal treatment composition to soybeans post-emergence, wherein the second herbicidal treatment composition comprises glyphosate and/or glufosinate.

### DETAILED DESCRIPTION OF THE INVENTION

Other than in the operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10, that is, having a minimum value equal to or greater than 1 and a maximum value of equal to or less than 10.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa; e. g., the singular forms “a,” “an,” and “the” include plural referents unless expressly and unequivocally limited to one referent.

With respect to the present invention, the phrase “effective amount” as used herein is intended to refer to an amount of an ingredient used such that a noticeable increase in soybean yield is observed from plants grown in soil treated using the method of the present invention, compared to soybeans grown in soil that did not receive such treatment.

As noted above, the method of the present invention comprises the steps of:
(i) applying an effective amount of a first herbicidal treatment composition to the soil surface prior to plant emergence, wherein the herbicidal treatment composition comprises isoxaflutole; and
(ii) applying an effective amount of a second herbicidal treatment composition to soybeans post-emergence, wherein the second herbicidal treatment composition comprises glyphosate and/or Glufosinate.

Soybeans that can be treated effectively using the method of the present method include those that have been genetically modified to be resistant to, i. e., tolerant of and hardy against herbicides. Examples of suitable soybeans include those modified to contain the FG72 trait and or FG72*A5547-127 trait.

Suitable sources of isoxaflutole (5-cyclopropyl-4-(2-methylsulfonyl-4-trifluoromethylbenzoyl) isoxazole) include BALANCE PRO, available from Bayer CropScience.

The first herbicidal treatment composition may be applied to the soil surface by any known method. For example, it may be applied by broadcast spray application to the soil surface prior to plant emergence. Alternatively, it may be spray applied to by broadcast spray and incorporated prior to planting.

In the method of the present invention, the first herbicidal treatment composition is applied in an effective amount to improve yield, typically in an amount of 30 to 40 g active ingredient (isoxaflutole)/hectare, often 35 g active ingredient/hectare.

The second step of the method of the present invention is applying an effective amount of a second herbicidal treatment composition to soybeans post-emergence. The second herbicidal treatment composition comprises glyphosate and/or glufosinate. Suitable sources of glyphosate include ROUNDUP ORIGINAL MAX, available from Monsanto. Glufosinate is available from Bayer CropScience as LIBERTY, IGNITE, or RELY.

The second herbicidal treatment composition may be applied to soybeans by any known method. For example, it may be spray applied to the soil surface as early as upon emergence of soybean plants, or as early as the 3-4 trifoliate stage of the soybean plant. Alternatively, the second herbicidal treatment composition may be applied post-emergence and as early as upon emergence of weeds, such as when weeds are 4-6 inches in height or when weeds are expected to adversely affect growth of the soybean plants.

In the method of the present invention, the second herbicidal treatment composition is applied in an effective amount to improve yield. In a particular embodiment, when the second treatment composition comprises glyphosate, it is applied in an amount of 1000-1100 g glyphosate/hectare, often 1060 g/hectare.

In certain embodiments of the present invention, the method further comprises a step of (iii) applying an effective amount of a third herbicidal treatment composition to soybeans after step (ii). The third herbicidal treatment composition comprises glyphosate and/or glufosinate and is the same as or different from the second herbicidal treatment composition. The third herbicidal treatment composition may, for example, be applied as early as upon emergence of weeds, such as when weeds are 4-6 inches in height or when weeds are expected to adversely affect growth of the soybean plants. When the third treatment composition comprises glyphosate, it is applied in an amount of 1000-1100 g glyphosate/hectare, often 1060 g/hectare.

Each of the herbicidal treatment compositions may further comprise one or more additional ingredients including but not limited to one or more safeners, fertilizers, pesticides, fungicides and/or additional herbicides. Suitable fungicides within the scope of the present invention include those identified in the Fungicide Resistance Action Committee (“FRAC”) Code List (Last Update December 2006) which is hereby incorporated herein in its entirety by reference. Particular fungicides include azoles, such as azaconazole, bitertanol, bromuconazole, cyproconazole, difenoconazole, diniconazole, epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimefon, triadimenol, triticonazole and combinations thereof. Other fungicides that may be included within the scope of the present invention include 2-phenylphenol; 8-hydroxyquinoline sulfate; acibenzolar-S-methyl; aldimorph; amidoflumet; ampropylfos; ampropylfos-potassium; andoprim; anilazine; azoxystrobin; benalaxyl; benodanil; benomyl; benthiavalicarb-isopropyl; benzamacril; benzamacril-isobutyl; bilanafos; binapacryl; biphenyl; blasticidin-s; bupirimate; buthiobate; butylamine; calcium polysulfide; capsimycin; captafol; captan; carbendazim; carboxin; carpropamid; carvone; chinomethionate; chlobenthiazone; chlorfenazole; chloroneb; chlorothalonil; chlozolinate; clozylacon; cyazofamide; cyflufenamide; cymoxanil; cyprodinil; cyprofuram; Dagger G; debacarb; dichlofluanid; dichlone; dichlorophen; diclocymet; diclomezine; dicloran; diethofencarb; diflumetorim; dimethirimol; dimethomorph; dimoxystrobin; diniconazole-m; dinocap; diphenylamine; dipyrithione; ditalimfos; dithianon; dodine; drazoxolon; edifenphos; ethaboxam; ethirimol; etridiazole; famoxadone; fenamidone; fenapanil; fenarimol; fenfuram; fenhexamid; fenitropan; fenoxanil; fenpiclonil; fenpropidin; fenpropimorph; ferbam; fluazinam; flubenzimine; fludioxonil; flumetover; flumorph; fluoromide; fluoxastrobin; flurprimidol; flusulfamide; flutolanil; folpet; fosetyl-al; fosetyl-sodium; fuberidazole; furalaxyl; furametpyr; furcarbanil; furmecyclox; guazatine; hexachlorobenzene; hymexazole; imazalil; iminoctadine triacetate; iminoctadine tris(albesilate); iodocarb; iprobenfos; iprodione; iprovalicarb; irumamycin; isoprothiolane; isovaledione; kasugamycin; kresoximmethyl; mancozeb; maneb; meferimzone; mefenoxam; mepanipyrim; mepronil; metalaxyl (N-(2,6-dimethylphenyl)-N-(methoxyacetyl)alanine methyl ester); metalaxyl-m; methasulfocarb; methfuroxam; metiram; metominostrobin; metsulfovax; mildiomycin; myclozolin; natamycin; nicobifen; nitrothal-isopropyl; noviflumuron; nuarimol; ofurace; orysastrobin; oxadixyl; oxolinic acid; oxpoconazole; oxycarboxin; oxyfenthi in ; paclobutrazol; pefurazoate; pencycuron; phosdiphen; phthalide; picoxystrobin; piperalin; polyoxins; polyoxorim; probenazole; prochloraz; procymidone; propamocarb; propanosine-sodium; propineb; proquinazid; pyraclostrobin; pyrazophos; pyrifenox; pyrimethanil; pyroquilon; pyroxyfur; pyrrolnitrine; quinconazole; quinoxyfen; quintozene; spiroxamine; sulfur; tecloftalam; tecnazene; tetcyclacis; thiabendazole; thicyofen; thifluzamide; thiophanate-methyl; thiram (tetramethylthiuram disulfide); tioxymid; tolclofos-methyl; tolylfluanid; triazbutil; triazoxide; tricyclamide; tricyclazole; tridemorph; trifloxystrobin; triflumizole; triforine; uniconazole; validamycin a; vinclozolin; zineb; ziram; zoxamide; (2S)-N-[2-[4-[[3-(4-chlorophenyl)-2-propinyl]oxy]-3-methoxyphenyl]ethyl]-3-methyl-2-[(methylsulfonyl)amino]-butanamide; 1-(1-naphthalenyl)-1H-pyrrol-2,5-dione; 2,3,5,6-tetrachloro-4-(methylsulfonyl)-pyridine; 2-amino-4-methyl-n-phenyl-5-thiazolcarboxamide; 2-chloro-N-(2,3-dihydro-1,1,3-trimethyl-1 H-inden-4-yl)-3-pyridincarboxami- de; 3,4,5-trichloro-2,6-pyridindicarbonitrile; actinovate; cis-1-(4-chlorophenyl)-2-(1H-1,2,4triazol-1-yl)-cycloheptanol; methyl-1-(2,3-dihydro-2,2-dimethyl-1H-inden-1-yl)-1-Himidazol-5-carboxylate; mono-potassium carbonate; n-(6-methoxy-3-pyridinyl)-cyclopropancarboxamide; n-butyl-8-(1,1 -dimethylethyl)-1-oxaspiro[4.5]decan-3-amine; sodium trathiocarbonate; and copper salts and preparations, such as: Bordeaux mixture, copper hydroxide, copper naphthenate, copper oxychloride, copper sulphate, cufraneb, copper oxide, mancopper, oxine-copper, and combinations thereof. Pesticides include but are not limited to insecticides, acaracides, nematacides and combinations thereof. In particular, acibenzolar-S-methyl, phorate, aldicarb, chlorothalonil, acephate, tebuconazole, and/or neonicotinoids such as imidacloprid, thiacloprid, acetamiprid, clothianidin, nitenpyram, and thiamethoxam are suitable for use as additional ingredients in the herbicidal treatment compositions. Each of these is available commercially and may be used in the method of the present invention in amounts conventionally recommended for their intended use. In particular embodiments of the present invention, the first herbicidal treatment composition further comprises the safener cyprosulfamide. The second and/or third treatment compositions often further comprise ammonium sulfate, available from Crop Production Services, Inc., as BENCHMARK AMS. Ammonium sulfate is typically used in an amount of 1 to 4 pounds/acre.

In addition to the foregoing, the herbicidal treatment compositions may include other components including but not limited to dyes, extenders, surfactants, defoamers and combinations thereof, as discussed below.

The herbicidal treatment compositions used in the method of the present invention may be provided in common forms known in the art, for example as emulsifiable concentrates, suspension concentrates, directly sprayable or dilutable solutions, coatable pastes, dilute emulsions, wettable powders, soluble powders, dispersible powders, dusts, granules or capsules. They may optionally include auxiliary agents commonly used in agricultural treatment formulations and known to those skilled in the art. Examples include but are not limited to wetting agents, dispersants, emulsifiers, penetrants, preservatives, antifreezes and evaporation inhibitors such as glycerol and ethylene or propylene glycol, sorbitol, sodium lactate, fillers, carriers, colorants including pigments and/or dyes, pH modifiers (buffers, acids, and bases), salts such as calcium, magnesium, ammonium, potassium, sodium, and/or iron chlorides, fertilizers such as ammonium sulfate as discussed above and ammonium nitrate, urea, and defoamers.

Suitable defoamers include all customary defoamers including silicone-based and those based upon perfluoroalkyl phosphinic and phosphonic acids, in particular silicone-based defoamers, such as silicone oils, for example.

Defoamers most commonly used are those from the group of linear polydimethylsiloxanes having an average dynamic viscosity, measured at 25° C., in the range from 1000 to 8000 mPas (mPas=millipascal-second), usually 1200 to 6000 mPas, and containing silica. Silica includes polysilicic acids, meta-silicic acid, ortho-silicic acid, silica gel, silicic acid gels, kieselguhr, precipitated SiO₂, and the like.

Defoamers from the group of linear polydimethylsiloxanes contain as their chemical backbone a compound of the formula HO—[Si(CH₃)₂—O—]ₙ—H, in which the end groups are modified, by etherification for example, or are attached to the groups —Si(CH₃)₃. Non-limiting examples of defoamers of this kind are RHODORSIL® Antifoam 416 (Rhodia) and RHODORSIL® Antifoam 481 (Rhodia). Other suitable defoamers are RHODORSIL® 1824, ANTIMUSSOL 4459-2 (Clariant), Defoamer V 4459 (Clariant), SE Visk and AS EM SE 39 (Wacker). The silicone oils can also be used in the form of emulsions.

Soybeans treated in accordance with the method of the present invention have demonstrated plant yield increases of at least 5%, often at least 8%, such as 8.4%.

The following example illustrates a spray treatment using the method of the present invention, demonstrating the enhanced yield of soybean.

Soybean seed was secured for an in-field research trial. The soybean seed is genetically modified to be tolerant to applications of HPPD (4-hydroxyphenyl-pyruvate-dioxygenase) inhibiting herbicides (example: BALANCE PRO or isoxaflutole) and glyphosate (ROUNDUP ORIGINAL MAX). The trait is known as FG72.

The site was conventionally tilled and free of weeds at the time of planting. The soybean seed was planted in 30″ rows on Jun. 18, 2008. Broadcast spray treatments of a first herbicidal treatment composition comprising isoxaflutole were applied using a tractor mounted sprayer on Jun. 20, 2008. All areas of the field, including a weed-free check (control) that was not treated with isoxaflutole, were additionally treated on Jun. 20, 2008, with PURSUIT PLUS herbicide, a combination of 2.24% imazethapyr and 30.24% pendimethalin, available from BASF. The application was made prior to soybean and weed emergence.

Weeds have been shown to have a significant impact on soybean yield. To avoid any interference of weed effects on yield in the trial, the entire trial site was kept weed free for the entire growing season. The method for keeping the entire trial site weed free was spray applications of a second herbicidal treatment composition comprising glyphosate at 1060 g ai/ha (active ingredient/hectare) plus ammonium sulfate at 2850 g ai/ha.

Each treatment consisted of four rows of soybeans and was replicated four times. The trial design was a randomized complete block. The trial was planted in Fithian, Ill.

The weed free check (control) that was not treated with isoxaflutole received two applications of glyphosate at 1060 g ai/ha plus ammonium sulfate at 2850 g ai/ha to prevent any negative effects of weeds on the soybean yield. The applications were made using a tractor mounted sprayer on Jul. 17, and Jul. 28, 2008. The plot area that was treated with isoxaflutole at 35 g ai/ha only required one application of glyphosate to maintain the area as weed free due to the soil residual properties of isoxaflutole. The application of glyphosate at 1060 g ai/ha plus ammonium sulfate at 2850 g ai/ha was made on Jul. 28, 2008 to the plots containing isoxaflutole.

The trial was evaluated for herbicidal treatment effect on yield. The trial was harvested with a two row plot combine on Oct. 22, 2008, where only the two center rows were harvested. Data collected included the fresh weight of the soybean seed yield and the moisture content of the seeds for each plot. Data was entered into and analyzed with ARM computer software. Data was standardized for moisture content. Data was also standardized for interpretation where the weed free check produced 100% yield. All other treatments were compared to yield based on a percent of the weed free check. Treatment differences were determined using least significant differences (LSD, P=0.05).

When averaged across all replications, the soybeans from the soil treatment of isoxaflutole at 35 g ai/ha yielded 108.5% of the comparative check. This was a statistically significant increase in yield compared to the weed free check.

Whereas particular embodiments of this invention have been described above for purposes of illustration, it will be evident to those skilled in the art that numerous variations of the details of the present invention may be made without departing from the invention as defined in the appended claims.

What is claimed is:

1. A method of improving the yield of a soybean plant, comprising the steps of:
(i) applying an effective amount of a first herbicidal treatment composition to the soil surface prior to plant emergence, wherein the herbicidal treatment composition comprises isoxaflutole; and
(ii) applying an effective amount of a second herbicidal treatment composition to soybeans post-emergence, wherein the second herbicidal treatment composition comprises glyphosate and/or glufosinate.

2. The method of claim 1, wherein the first herbicidal treatment composition is applied before planting.

3. The method of claim 1, wherein the first herbicidal treatment composition is applied during or after planting.

4. The method of claim 1, wherein the herbicidal treatment compositions are spray applied.

5. The method of claim 1, wherein the first herbicidal treatment composition is applied in an amount of 30 to 40 g active ingredient/hectare.

6. The method of claim 1, wherein the first herbicidal treatment composition is applied in an amount of 35 g active ingredient/hectare.

7. The method of claim 1, wherein the plant yield is increased by at least 5%.

8. The method of claim 1, wherein the plant yield is increased by at least 8%.

9. The method of claim 1, wherein the herbicidal treatment compositions further comprise safeners, pesticides, fertilizers, other herbicides, and/or fungicides.

10. The method of claim 9, wherein the first herbicidal treatment composition further comprises cyprosulfamide.

11. The method of claim 9, wherein the second herbicidal treatment composition further comprises ammonium sulfate.

12. The method of claim 1 wherein the herbicidal treatment compositions further comprise dyes, extenders, surfactants, and/or defoamers.

13. The method of claim 1, wherein the second herbicidal treatment composition is applied as early as upon emergence of soybean plants.

14. The method of claim 1, wherein the second herbicidal treatment composition is applied as early as the 3-4 trifoliate stage of the soybean plant.

15. The method of claim 1, wherein the second herbicidal treatment composition comprises glyphosate, applied in an amount of 1000-1100 g/hectare.

16. The method of claim 1, further comprising a step of (iii) applying an effective amount of a third herbicidal treatment composition to soybeans after step (ii), wherein the third herbicidal treatment composition comprises glyphosate and/or glufosinate and is the same as or different from the second herbicidal treatment composition.

17. The method of claim 16, wherein the third herbicidal treatment composition is applied as early as upon emergence of weeds.

18. The method of claim 16, wherein the third herbicidal treatment composition comprises glyphosate, applied in an amount of 1000-1100 g/hectare.
